(19) United States
(12) Patent Application Publication
(10) Pub. No.: US 2012/0021143 A1
(43) Pub. Date: Jan. 26, 2012

(54) DISPLAY DEVICE

(75) Inventors: Takato HIRATSUKA, Chiba (JP); Masaya Adachi, Hitachi (JP); Osamu Itou, Hitachi (JP)

(73) Assignees: Panasonic Liquid Crystal Display Co., Ltd.; Hitachi Displays, Ltd.

(21) Appl. No.: 13/186,561

(22) Filed: Jul. 20, 2011

(30) Foreign Application Priority Data
Jul. 21, 2010 (JP) 2010-163572

(51) Int. Cl. C09K 19/04; C09K 19/34; C09K 19/32; G02F 1/13; C09K 19/12

(52) U.S. Cl. 428/1.31

(57) ABSTRACT

A display device capable of improving the contrast ratio and having a polarizing layer formed by applying shear stress to a material containing a dye having a lyotropic liquid crystallinity to align the molecule of the dye, wherein the display device has an underlayer film forming a base for the polarizing layer, the molecule of the dye has a sulfo group, and the underlayer film comprises a material having a basic surface functional group.

### CLAIM OF PRIORITY

The present application claims priority from Japanese Patent Application JP 2010-163572 filed on Jul. 21, 2010, the content of which is hereby incorporated by reference into this application.

### BACKGROUND OF THE INVENTION

1. Field of the Invention

The present invention relates to a display device having a polarizing layer in which a dye molecule is aligned by applying a shear stress to a material containing a dye having lyotropic liquid crystallinity.

2. Description of the Related Art

A polarizing device having a polarizing layer in which dye molecules are aligned by applying shear stress to a material containing a dye having lyotropic liquid crystallinity has been proposed (for example, refer to JP-A-2007-240906). The lyotropic liquid crystallinity means that a material shows a property similar to that of liquid crystal in a state of solution dissolved in a solvent. The dye having the lyotropic liquid crystallinity is soluble, for example, to water which is used suitably as a solvent. Further, in the material containing a dye having the lyotropic liquid crystallinity, dye molecules are aligned in one direction by applying a shear stress to the material that is in the state of the solution upon coating a base, and the solution is dried after the coating and completed as a polarizing layer. In the material containing the dye having the lyotropic liquid crystallinity, the alignment property of the dye molecules is improved more as a larger shear stress is applied to the material that is in the state of the solution upon coating a base.

In the polarizing device described in JP-A-2007-240906, when a material containing a dye having a lyotropic liquid crystallinity is used in the state of a solution for coating a substrate as a base, shear stress is applied to the material in the polarizing device. In the polarizing device, for improving the alignment property of the dye molecule, the evaporation rate of the solvent is controlled when the material is dried. Since the polarizing device obtained as described above can obtain a high optical property, it is applied, for example, to a display device.

### SUMMARY OF THE INVENTION

However, in the display device using the polarizing device as described in JP-A-2007-240906, since the material is separated from the substrate when a large shear stress is applied to the material upon coating the material containing the dye having the lyotropic liquid crystallinity on the substrate, it is difficult to apply a large shear stress to the material and, as a result, it was difficult to increase the contrast ratio.

The present invention has been accomplished in view of the foregoings and intends to provide a display device capable of increasing the contrast ratio.

To solve the subject and attaining the object described above, the present invention provides, in one aspect, a display device comprising:

a polarizing layer formed by applying a shear stress to a material containing a dye having lyotropic liquid crystallinity thereby aligning molecules of the dye; and

an underlayer film for forming a base for the polarizing layer;

wherein the molecule of the dye has at least one acidic group, and

wherein the underlayer film comprises a material having a basic surface functional group.

In a preferred embodiment of the invention, the dye material of the polarizing layer is a lyotropic liquid crystal and the dye molecule has at least one functional group which is the acidic group.

The dye is selected from at least one member in a group of dyes including anthraquinone dye, phthalocyanine dye, porphyrin dye, naphthalocyanine dye, quinacridone dye, dioxazine dye, indanthrene dye, acridine dye, perylene dye, pyrazolone dye, acridone dye, pyranthrone dye, and isopyranthrone dye.

In another embodiment of the display device according to the invention, the material having the basic surface functional group is a silane coupling agent.

The display device according to the invention comprises: a polarizing layer formed by applying a shear stress to a material containing a dye having lyotropic liquid crystallinity thereby aligning molecules of the dye; and an underlayer film for forming a base for the polarizing layer; wherein the molecule of the dye has at least one acidic group, and wherein the underlayer film comprises a material having a basic surface functional group.

Accordingly, an acid-base interaction is caused between the acidic group for the dye molecule and the basic group which is the surface functional group for the underlayer film to strengthen a force of fixing the dye molecule having the lyotropic liquid crystallinity to the surface of the underlayer film.

Therefore, since a large shear stress can be applied to the material, the dye alignment property of the polarizing layer is improved and, as a result, the contrast ratio can be increased.

### BRIEF DESCRIPTION OF THE DRAWINGS

FIG. 1 is a diagram schematically showing the configuration of a liquid crystal display device according to an embodiment of the invention;

FIG. 2 is a condition table showing conditions for forming an underlayer film using a silane coupling agent A;

FIG. 3 is a condition table showing conditions for forming polarizing layer;

FIG. 4 is a graph showing a relation between a total light transmittance and a contrast ratio of a coating type polarizing plate shown in FIG. 1 and an existent coating type polarizing plate;

FIG. 5 is a diagram schematically showing the configuration of an existent coating type polarizing plate;

FIG. 6 is a diagram schematically showing the configuration of a coating type polarizing plate having an underlayer film using a silane coupling agent B;

FIG. 7 is a graph showing a relation between a total light transmittance and a contrast ratio for the coating type polarization plate shown in FIG. 1 and the coating type polarizing plate shown in FIG. 5;

FIG. 8 is a table showing comparison of the contrast ratio at a total light transmittance of 40%; and

FIG. 9 is a diagram schematically showing a fragmentary section of an OLED display device as a modified embodiment of the invention.

### DESCRIPTION OF THE PREFERRED EMBODIMENTS

An embodiment of a display device according to the invention is to be described in details with reference to the drawings.

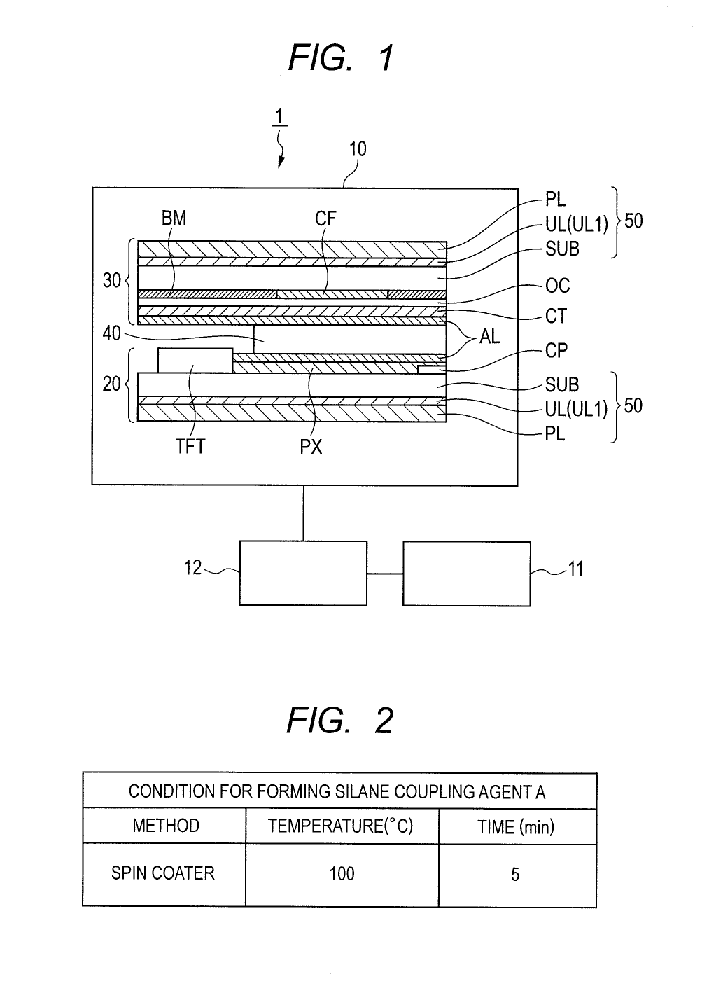

FIG. 1 is a schematic diagram showing a configuration of a liquid crystal display device 1 according to an embodiment of the invention. The liquid crystal display device 1 is an active matrix driving type liquid crystal display device and has a liquid crystal panel 10, a backlight 11, and a control section 12 as shown in FIG. 1. In FIG. 1, the liquid crystal panel 10 is shown as a cross section for a main portion.

The liquid crystal display panel 10 has a TFT substrate 20, a color filter substrate 30, and a liquid crystal material 40 put therebetween.

The TFT substrate 20 has a glass substrate SUB, a thin film transistor TFT, a pixel electrode PX, an accumulation capacitor CP, and an alignment film AL.

The glass substrate SUB is a transparent substrate made of a glass material. The thin film transistor TFT is a switching device for driving liquid crystals. The pixel electrode PX is an ITO (Indium Tin Oxide) electrode for display as a pixel. The accumulation capacitor CP is a signal holding capacitor for holding a voltage of the pixel electrode PX also in the state where the thin film transistor TFT is being turned off. The alignment film AL is a thin film, for example, made of polyimide and aligns the liquid crystals.

The color filter substrate 30 has a glass substrate SUB, a color filter CF, a black matrix BM, an overcoat film OC, a common electrode CT and an alignment film AL.

The color filter CF is a resin film containing a dye or a pigment having three primary colors of red (R), green (G), and blue (B). The black matrix BM is a light shielding film disposed between the pixels of the color filter CF. The overcoat film OC is a resin film for protecting the color filter CF. The common electrode CT is an ITO (Indium Tin Oxide) electrode.

Further, the liquid crystal display panel 10 has an underlayer film UL and a polarizing layer PL. The underlying film UL is a film coated on the glass substrate SUB. The underlying film UL comprises a material having a basic surface function group. The basic group is a functional group having Pka of 7 or greater in an aqueous solution with addition of an inert support electrolyte by 0.1 to 3 mol/dm respectively. Pka is a logarithmic value for the reciprocal of acid dissociation constant ka for concentration, that is, −log (ka) (described in Chemical Manual, basic edition II, P. 331). Examples of the basic groups include amino group, sulfonium group, pyrrol group, 3-pyrroline group, pyrrolidine group, pyrazole group, 2-pyrazoline group, pyrazolidine group, imidazole group, pyridine group, pyridazine group, piperidine group, pyrazine group, pyrimidine group, triazine group, etc.

In this embodiment, a silane coupling agent is used as the underlayer film UL. An underlayer film UL1 using, as a silane coupling agent, KBM573 manufactured by Shin-Etsu Chemical Co. having an amino group as the surface functional group (hereinafter referred to as a silane coupling agent A) is used as the underlayer film UL. The silane coupling agent A has an amino group and a methoxy group in one molecule. When the silane coupling agent A is formed on the glass substrate SUB, methoxy groups are bonded to the hydroxyl groups on the surface of the glass substrate SUB. Thus, the surface functional groups of the glass substrate SUB are covered with the amino groups.

Then, the conditions for forming the underlayer film UL1 using the silane coupling agent A are to be described. FIG. 2 is a condition table showing conditions of forming the underlayer film UL1 using the silane coupling agent A. The underlayer film UL1 is coated on the glass substrate SUB by a spin coater and dried at a temperature of 100° C. for five minutes. The underlayer film UL1 is set to a thickness, for example, of 2 to 3 nm. The conditions for forming the underlayer film UL1 show one example and are not restricted thereto. That is, parameters such as temperature, time, and thickness can be set optionally. For example, spontaneous drying may be applied as the drying method.

The polarizing layer PL is a layer formed on the underlayer film UL1 as a base and transmits or absorbs predetermined polarizing ingredients. The polarizing layer PL is formed of a coating solution as a material containing the dye having the lyotropic liquid crystallinity. In the dye of the lyotropic liquid crystal, an acidic sulfo group is present. This is because the lyotropic liquid crystal material whose state of phase changes depending on the concentration of water tend to be soluble to water. The lyotropic liquid crystalline dye includes, for example, dyes selected from the group consisting, for example, of anthraquinone dye, phthalocyanine dye, porphyrin dye, naphthalocyanine dye, quinacridone dye, dioxazine dye, indanthrene dye, acridine dye, perylene dye, pyrazolone dye, acridone dye, pyranthrone dye, and isopyranthrone dye. One of the dyes may be contained alone or two or more of them may be contained at optional ratio of combination and in optional combination.

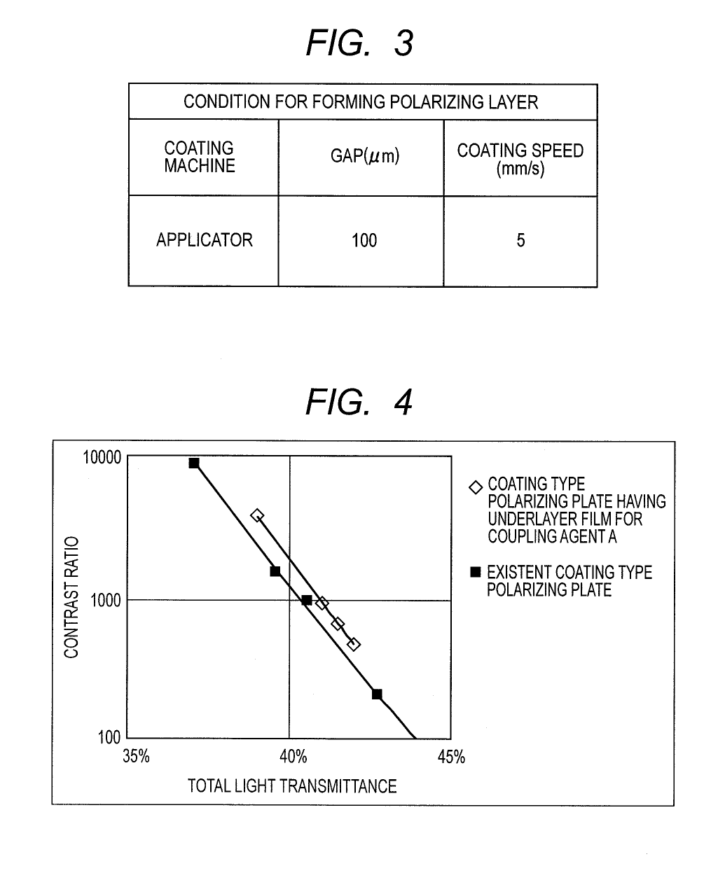

Then, conditions for forming the polarizing layer PL are to be described. FIG. 3 is a condition table showing conditions for forming the polarizing layer PL. As shown in FIG. 3, an applicator is used as a coating machine. The applicator is set to a gap of 6 μm and a coating speed of 125 mm/s. The polarizing layer PL is formed by dropping the coating solution described above by the applicator to the underlayer film UL1 formed on the glass substrate SUB and moving the applicator in the coating direction. A shear stress is applied by the movement to the coating solution and the dyes are aligned in the shearing direction.

The conditions for forming the polarizing layer PL show one example and they are not restricted thereto. That is, various parameters such as gap and the coating speed may be set optionally. Further, while the applicator is exemplified as the coating machine, it is not limitative. It may suffice that the coating machine can coat the coating solution under the application of the shear stress and, for example, a bar coater or a slit coater may also be used.

The liquid crystal display device 1 having such a configuration has, as shown in FIG. 1, a coating type polarizing plate 50 having the glass substrate SUB, the underlayer film UL1, and the polarizing layer PL.

A relation between the total light transmittance and the contrast ratio is shown for the coating type polarizing plate 50 and the existent coating type polarizing plate, and the contrast ratio is compared between the coating type polarizing plate 50 having the underlayer film UL1 using the silane coupling agent A and the existent coating type polarizing plate.

FIG. 4 is a graph showing the relation between the total light transmittance and the contrast ratio for the coating type polarizing plate 50 shown in FIG. 1 and the existent coating polarizing plate.

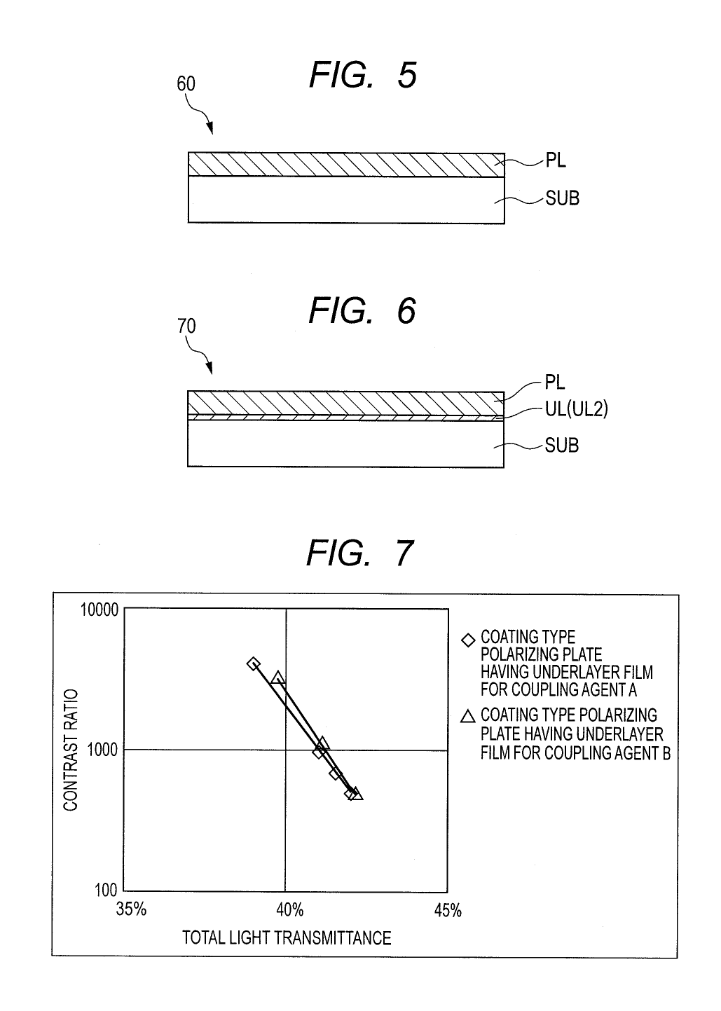

FIG. 5 is a diagram schematically showing the configuration of an existent coating type polarizing plate 60. The contrast ratio is a ratio of luminance when absorption axes of two coating type polarizing plates 50 are made in parallel and orthogonal to each other (white luminance/black luminance).

Further, the existent coating type polarizing plate is a coating type polarizing plate 60 in which a polarizing plate PL is formed directly on a glass substrate SUB not by way of an underlayer film UL. According to the result shown in FIG. 4, the contrast ratio for the coating type polarizing plate 50 at a 40% total light transmittance is 2000, and a contrast ratio about 1.7 times as high as the contrast ratio of 1200 for the existent coating polarizing plate 60 is obtained.

Then, the contrast ratio is compared between the coating type polarizing plate 50 having the underlayer film UL1 using the silane coupling agent A and a coating type polarizing plate using KBM 903 manufactured by Shin-Etsu Chemical having a surface functional group of higher bacidity than the silane coupling agent A (hereinafter referred to as a silane coupling agent B).

FIG. 6 is a diagram schematically showing the configuration of a coating type polarizing plate 70 having an underlayer film UL2 using the silane coupling agent B.

FIG. 7 is a graph showing a relation between the total light transmittance and the contrast ratio for the coating polarizing plate 50 and the coating polarizing plate 70.

As shown in FIG. 6, the coating type polarizing plate 70 having the underlayer film UL2 using the silane coupling agent B has a glass substrate SUB, an underlayer film UL2 formed on the glass substrate SUB by using the silane coupling agent B, and a polarizing layer PL formed on the glass substrate SUB by way of the underlayer film UL2.

The intensity of the bacidity is concerned with the concentration of non-covalent electron pairs on a nitrogen atom (electron density). In the silane coupling agent A, since the non-covalent electron pairs flow into a benzene ring, the electron density is lowered. On the other hand, benzene ring is not present in the silane coupling agent B.

Then, the electron density of the silane coupling agent B is higher and the bacidity is stronger than those of the silane coupling agent A. As a result, the higher contrast ratio is obtained for the coating type polarizing plate 70 of the silane coupling agent B than the contrast ratio for the coating type polarizing plate 50 of the silane coupling agent A at the total light transmittance of 40% as shown in FIG. 7.

Then, the contrast ratio is compared between the coating type polarizing plate 50 having the underlayer film UL1 using the silane coupling agent A, the coating type polarizing plate 70 having the underlayer film UL2 using the silane coupling agent B, and the existent coating type polarizing plate 60.

FIG. 8 is a table comparing the contrast ratio at the total light transmittance of 40%. According to the result shown in FIG. 8, the contrast ratio of the coating type polarizing plate 70 having the underlayer film U2 using the silane coupling agent B of higher bacidity is about 1.2 times as high as the coating type polarizing plate 50 having the underlayer film U1 using the silane coupling agent A.

Further, the contrast ratio for the coating type polarizing plate 70 having the underlayer film U2 using the silane coupling agent B was 1.9 times as high as the contrast ratio for the existent coating type polarizing plate 60. In view of the above, it can be seen that the dye alignment property of the polarizing layer PL is improved and high contrast ratio can be obtained by providing surface functional groups having higher bacidity as the underlayer film UL for the polarizing layer PL.

It is considered that the result is attributable to that acid-base interaction is caused between the sulfo group for the dye molecule of the dye having the lyotropic liquid crystallinity contained in the polarizing layer PL and the basic group as the surface functional group for the underlayer film UL to strengthen the force of fixing the surface of the underlayer film UL to the polarizing layer PL.

The coating type polarizing plate 50, 60, 70 is one of the factors for determining the contrast ratio for the liquid crystal display device 1. Then, when the optical property of the coating type polarization plate 50, 60, 70 is doubled, the contrast ratio for the liquid crystal display device 1 also doubled substantially.

In the embodiment of the invention, the liquid crystal display device 1 has the underlayer film UL forming a base for the polarizing layer PL, the polarizing layer PL is formed of a coating solution containing a lyotropic liquid crystalline dye having the sulfo group in the molecule of dye, and the underlayer film UL has a basic surface functional group as described above.

Accordingly, acid-base interaction is caused between the sulfo group for the dye molecule and the basic group as the surface functional group for the underlayer film UL to strengthen the force of fixing the surface of the underlayer film UL to the polarizing layer PL. Therefore, since a large shear stress can be applied to the coating solution, the dye alignment property of the polarizing layer PL can be improved and, as a result, the contrast ratio can be increased.

Further, in the embodiment of the invention, since the coating solution containing the lyotropic liquid crystalline dye as the material is less repelled relative to the glass substrate upon forming the polarizing layer PL, uniformity in the plane on the glass substrate SUB is enhanced and, as a result, the yield can be improved. Modification

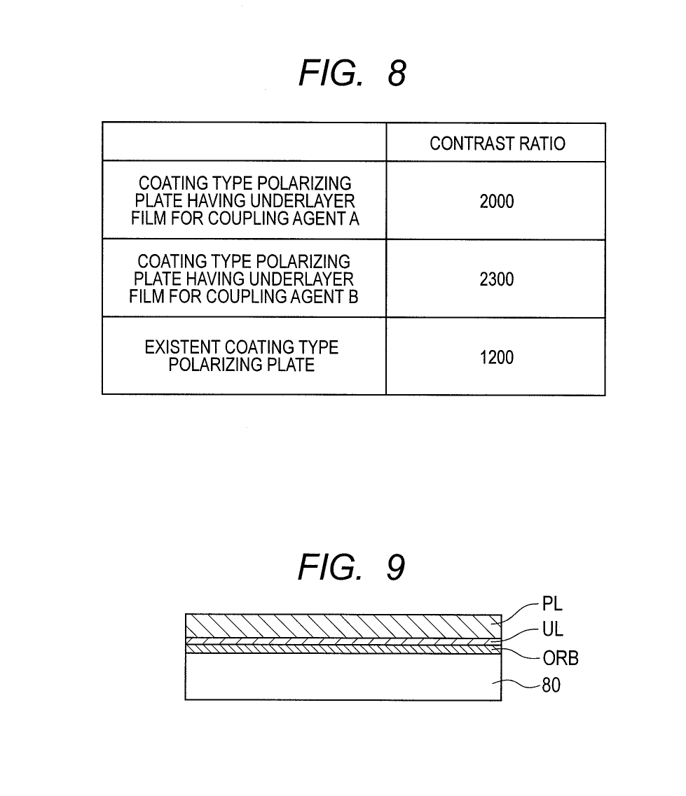

Then, a modification of the embodiment according to the invention is to be described with reference to FIG. 9. FIG. 9 is a diagram showing a modified example of the embodiment according to the invention.

While the embodiment of the invention in which the liquid crystal display device 1 has the polarizing layer PL using the underlayer film UL as a base has been illustrated, a display device having the polarizing layer PL using the underlayer film UL as a base may be applied to a display device such as a 3D display device. Then, this modified example illustrates an OLED (organic light emitting device) display device having the polarizing layer PL using the underlayer film as a base.

The OLED display device has an OLED panel 80 and a λ/4 plate ORB as shown in FIG. 9. The OLED panel 80 is a substrate formed with an organic UL layer. The λ/4 plate ORB is a retardation plate comprising polycarbonate or the like. Since the OLED panel 80 uses an electrode comprising aluminum, etc. external light is reflected in the OLED panel 80 to worsen the display performance remarkably, external reflection is suppressed in the λ/4 plate ORB.

In this modified example, the underlayer film UL is formed on the λ/4 plate ORB, and the polarizing layer PL is formed over the underlayer film UL as a base. Therefore, the OLED display device can improve the contrast ratio in the same manner as the liquid crystal device 1.

While the embodiment of the invention using the silane coupling agent A or B for the underlayer film UL has been illustrated, it is not limitative and any underlayer film UL comprising the material having the basic surface functional group may be used.

While the invention made by the present inventors has been described specifically with reference to the embodiments of the invention described above, the invention is not restricted to the embodiment of the invention described above but can be modified variously within a range not departing from the gist thereof.

What is claimed is:

1. A display device comprising:
a polarizing layer formed by applying a shear stress to a material containing a dye having lyotropic liquid crystallinity to align molecules of the dye; and
an underlayer film for forming a base for the polarizing layer;
wherein the molecule of the dye has at least one acidic group, and
wherein the underlayer film comprises a material having a basic surface functional group.

2. The display device according to claim 1, wherein the dye is selected from at least one of dyes in the dye group consisting of anthraquinone dye, phthalocyanine dye, porphyrin dye, naphthalocyanine dye, quinacridone dye, dioxazine dye, Indanthrene dye, acridine dye, perylene dye, pyrazolone dye, acridone dye, pyranthrone dye, and isopyranthrone dye.

3. The display device according to claim 1, wherein the material having the basic functional group is a silane coupling agent.

4. The display device according to claim 2, wherein the material having the basic functional group is a silane coupling agent.
